(19) United States
(12) Patent Application Publication
(10) Pub. No.: US 2005/0018911 A1
(43) Pub. Date: Jan. 27, 2005

(54) Foveated video coding system and method

(75) Inventor: Aaron T. Deever, Rochester, NY (US)

Correspondence Address: Thomas H. Close;Patent Legal Staff, Eastman Kodak Company, 343 State Street, Rochester, NY, 14650-2201, US

(73) Assignee: Eastman Kodak Company

(21) Appl. No.: 10/626,023

(22) Filed: Jul. 24, 2003

(51) Int. Cl. G06K 9/36

(52) U.S. Cl. 382/232

(57) ABSTRACT

In transcoding a frequency transform-encoded digital video signal representing a sequence of video frames, a foveated, compressed digital video signal is produced and transmitted over a limited bandwidth communication channel to a display according to the following method: First, a frequency transform-encoded digital video signal having encoded frequency coefficients representing a sequence of video frames is provided, wherein the encoding removes temporal redundancies from the video signal and encodes the frequency coefficients as base layer frequency coefficients in a base layer and as residual frequency coefficients in an enhancement layer. Then, an observer's gaze point is identified on the display. The encoded digital video signal is partially decoded to recover the frequency coefficients, and the residual frequency coefficients are adjusted to reduce the high frequency content of the video signal in regions away from the gaze point. The frequency coefficients, including the adjusted residual frequency coefficients, are then recoded to produce a foveated, transcoded digital video signal, and the foveated, transcoded digital video signal is displayed to the observer.

### FIELD OF INVENTION

This invention pertains to the field of video compression and transmission, and in particular to a video coding system and method which incorporate foveation information to decrease video bandwidth requirements.

### BACKGROUND OF THE INVENTION

In recent years, many methods for digital video compression have been proposed. Many of these methods, such as the MPEG 2 video compression standard, as described in “Information Technology—Generic Coding of Moving Pictures and Associated Audio Information: Video, ISO/IEC International Standard 13818-2,” exploit both spatial and temporal redundancies in the video data to reduce the bandwidth necessary to accurately represent the data. Stereo video sequences are also handled by the MPEG 2 standard, which uses a multiview profile to code stereo, exploiting correlation between the left and right eye views to decrease the necessary bandwidth to represent the data.

The human visual system can also be considered to further reduce the bandwidth necessary to represent a video sequence. Foveated coding systems encode different regions of an image with varying resolution and/or fidelity based on the gaze point of the observer. Regions of an image removed from an observer's gaze point can be aggressively compressed due to the observer's decreasing sensitivity away from the point of gaze.

For video sequences of high resolution and wide field of view, such as may be encountered in an immersive display environment, efficient compression is critical to reduce the data to a manageable bandwidth. This compression can be achieved both through standard video coding techniques that exploit spatial and temporal redundancies in the data as well as through foveated video coding. Additionally, the video sequence may need to be initially encoded off-line for two reasons: first, the large size of the video sequence may prohibit real-time encoding, and second, limited available storage space for the video sequence may prevent storage of the uncompressed video. One example of such an application is transmission of streaming video across a network with limited bandwidth to an observer in an immersive home theater environment. The high data content of the immersive video and the limited bandwidth available for transmission necessitate high compression. The large size of the video frames also necessitates off-line encoding to ensure high quality encoding and also allow real-time transmission and decoding of the video. Because the video must initially be encoded off-line, foveated video processing based on actual observer gaze point data cannot be incorporated into the initial encoding. Instead, the compressed video stream is transcoded at the server to incorporate additional foveation-based compression.

Geisler et al. in U.S. Pat. No. 6,252,989 describe a foveated image coding system. Their system is designed, however, for sequences which can be encoded in real-time after foveation information is transmitted to the encoder. Additionally, each frame of the sequence is coded independently, thus not exploiting temporal redundancy in the data and not achieving maximal compression. The independent encoding of individual frames does not extend well to stereo sequences either, as it fails to take advantage of the correlation between the left and right eye views of a given image. Weiman et al (U.S. Pat. No. 5,103,306) describe a similar system for real-time independent encoding of video frames incorporating foveation information to decrease the bandwidth of the individual frames.

Lee et al. (“Foveated Video Compression with Optimal Rate Control,” IEEE Transactions on Image Processing, July 2001) describe a video coding system which incorporates motion estimation and compensation in the compression scheme to exploit temporal redundancies in the data, as well as incorporating foveation coding to further decrease bandwidth. Their system, however, is also designed for sequences that can be encoded in real-time.

In commonly assigned U.S. Ser. No. 09/971,346 (“Method and System for Displaying an Image,”), which was also published as EP1301021A2 on 9 Apr. 2003, Miller et al. introduce an encoding scheme in which a video sequence is initially compressed using JPEG2000 compression on individual frames. Bandwidth is subsequently further decreased by selectively transmitting portions of the compressed image based on foveation information. While this system allows the video sequence to be initially encoded off-line, it does not exploit temporal redundancy in the video data to achieve maximal compression. Nor does it extend well to stereo sequences, as the individual encoding of frames precludes taking advantage of the correlation between left and right eye views of an image.

There is a need, therefore, for a video coding system which initially encodes a video sequence independent of any foveation information, yet exploiting both temporal and spatial redundancies in the video data. Additionally, there is a need for this system to efficiently encode stereo video sequences, exploiting the correlation between left and right eye sequences. There is also a need for this system to encode the video in such a manner that the bandwidth required to subsequently transmit the video sequence can be further reduced at a server by foveated video processing.

### SUMMARY OF THE INVENTION

It is an object of the present invention to encode the video sequence in such a way that the bandwidth required to subsequently transmit the sequence can be further reduced at the server by foveated video processing.

It is a further object of the present invention to provide a system and method which efficiently encode a video sequence, exploiting both spatial and temporary redundancies in the video sequence, as well as exploiting left eye and right eye correlations in stereo sequences.

The present invention is directed to overcoming one or more of the problems set forth above. Briefly summarized, according to one aspect of the present invention, the invention resides in a method for transcoding a frequency transform-encoded digital video signal representing a sequence of video frames to produce a compressed digital video signal for transmission over a limited bandwidth communication channel to a display, where the method comprises the steps of: (a) providing a frequency transform-encoded digital video signal having encoded frequency coefficients representing a sequence of video frames, wherein the encoding removes temporal redundancies from the video signal and encodes the frequency coefficients as base layer frequency coefficients in a base layer and as residual frequency coefficients in an enhancement layer; (b) identifying a gaze point of an observer on the display; (c) partially decoding the encoded digital video signal to recover the frequency coefficients; (d) adjusting the residual frequency coefficients to reduce the high frequency content of the video signal in regions away from the gaze point; (e) recoding the frequency coefficients, including the adjusted residual frequency coefficients, to produce a foveated transcoded digital video signal; and (f) displaying the foveated transcoded digital video signal to the observer.

The present invention has the advantage that it efficiently encodes the sequence in such a manner that allows a server to further reduce the necessary bandwidth to transmit the sequence by incorporating foveated video processing. Additionally, it efficiently encodes a video sequence, exploiting spatial, temporal and stereo redundancies to maximize overall compression.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 shows a diagram of the encoding and storage of a video sequence.

FIG. 2 shows a diagram of the transcoding, transmission, decoding and display of a compressed video sequence according to the present invention.

FIG. 3 shows a diagram of the structure of a video sequence compressed using fine granularity scalability of the streaming video profile of MPEG 4.

FIG. 4 shows a diagram of the preferred embodiment of the video transcoding and transmission unit of FIG. 2 according to the present invention.

FIG. 5 shows further details of the enhancement layer foveation processing unit of the present invention as shown in FIG. 4.

FIG. 6 shows an example of the discardable coefficient bitplanes for a foveated DCT block in the enhancement layer.

FIG. 7 shows a flow chart of the video compression unit of FIG. 1 when JPEG2000 is used in a motion-compensated video compression scheme.

FIG. 8 shows a flow chart of the video transcoding and transmission unit of FIG. 2 used with a JPEG2000 encoded video sequence.

FIG. 9 shows the structure of a stereo video sequence compressed using the MPEG 2 multiview profile in the base layer, and a bitplane DCT coding of residual coefficients in the enhancement layer.

FIG. 10 shows a diagram of the video transcoding and transmission unit used with a stereo video sequence.

FIG. 11 shows a diagram of the structure of a stereo video sequence compressed using fine granularity scalability of the streaming video profile of MPEG 4.

### DETAILED DESCRIPTION OF THE INVENTION

Because image processing systems employing foveated video coding are well known, the present description will be directed in particular to attributes forming part of, or cooperating more directly with, method and system in accordance with the present invention. Attributes not specifically shown or described herein may be selected from those known in the art. For instance, elements of the cited encoding systems, e.g., MPEG 2 and 4 and JPEG2000, are also well known in the art and numerous references in the art may be consulted for details of their implementation. In the following description, a preferred embodiment of the present invention would ordinarily be implemented as a software program, although those skilled in the art will readily recognize that the equivalent of such software may also be constructed in hardware. Given the description according to the invention in the following materials, software not specifically shown, suggested or described herein that is useful for implementation of the invention is conventional and within the ordinary skill in such arts. If the invention is implemented as a computer program, the program may be stored in conventional computer readable storage medium, which may comprise, for example; magnetic storage media such as a magnetic disk (such as a floppy disk or a hard drive) or magnetic tape; optical storage media such as an optical disc, optical tape, or machine readable bar code; solid state electronic storage devices such as random access memory (RAM), or read only memory (ROM); or any other physical device or medium employed to store a computer program.

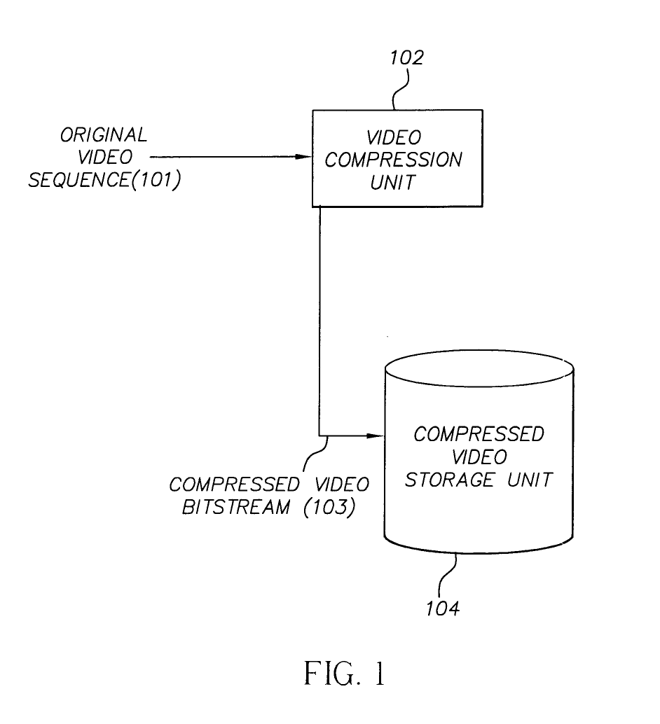

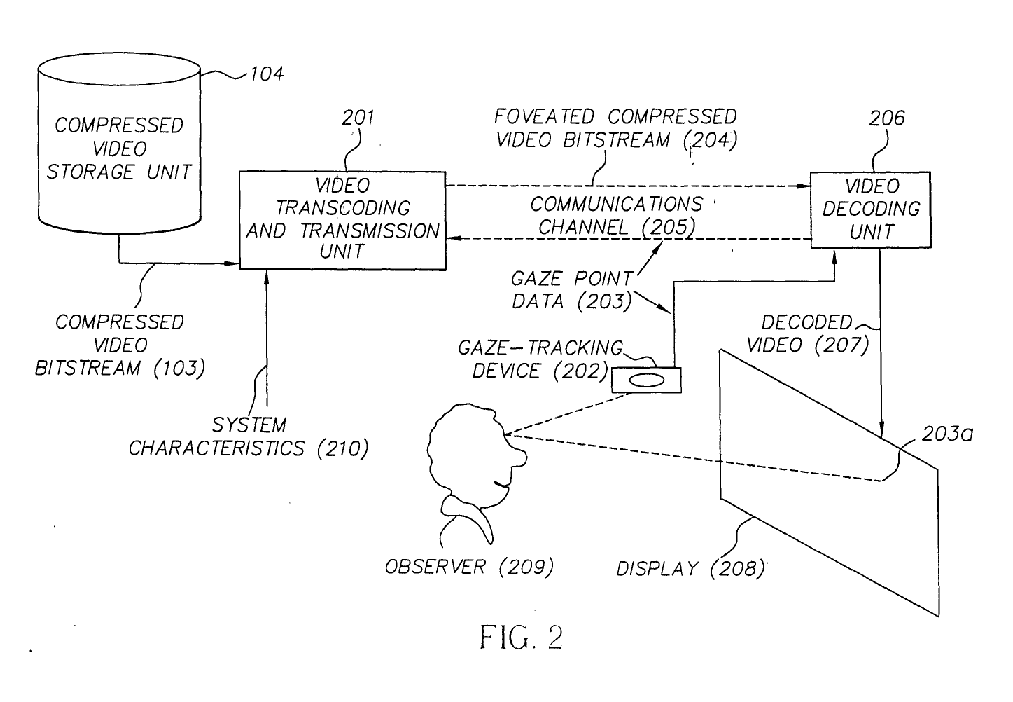

The video sequence to be transmitted is initially encoded off-line. This may be necessary for one of several reasons. For applications involving high resolution or stereo video, it may not be possible to encode the video sequence with high compression efficiency in real-time. Storage space may also be limited, necessitating the storage of the video in compressed format. FIG. 1 shows the initial compression process. The original video sequence (101) is sent to a video compression unit (102), which produces a compressed video bitstream (103) that is placed in a compressed video storage unit (104). The design of the video compression unit depends on whether the video sequence is a stereo sequence or a monocular sequence. FIG. 2 shows the subsequent transcoding and transmission of the compressed video bitstream to a decoder and ultimately to a display. The compressed video (103) is retrieved from the compressed video storage unit (104) and input to a video transcoding and transmission unit (201). Also input to the video transcoding and transmission unit is gaze point data (203) from a gaze-tracking device (202) that indicates the observer's (209) current gaze point (203a) on the display (208). In a preferred embodiment, the gaze-tracking device utilizes either conventional eye-tracking or head-tracking techniques to determine an observer's point of gaze (203a). The gaze-tracking device may report the current gaze location, or it may report a computed estimate of the gaze location corresponding to the time the next frame of data will be displayed. The video transcoding and transmission unit (201) also receives as input, system characteristics (210). The system characteristics are necessary to convert pixel measurements into viewing angle measurements, and may include the size and active area of the display, and the observer's distance from the display. The system characteristics also include a measurement of the error in the gaze-tracking device's estimate of the point of gaze (203a). This error is incorporated into the calculation of the amount of data that can be discarded from each region of an image according to its distance from the gaze location.

Based on the current gaze location, the video transcoding and transmission unit (201) modifies the compressed data for the current video frame, forming a foveated compressed video bitstream (204), and sends it across the communications channel (205) to a video decoding unit (206). The decoded video (207) is sent to the display (208). The gaze-tracking device (202) then sends an updated value for the observer's point of gaze (203a) and the process is repeated for the next video frame.

MPEG4-Based Foveated Video Coder

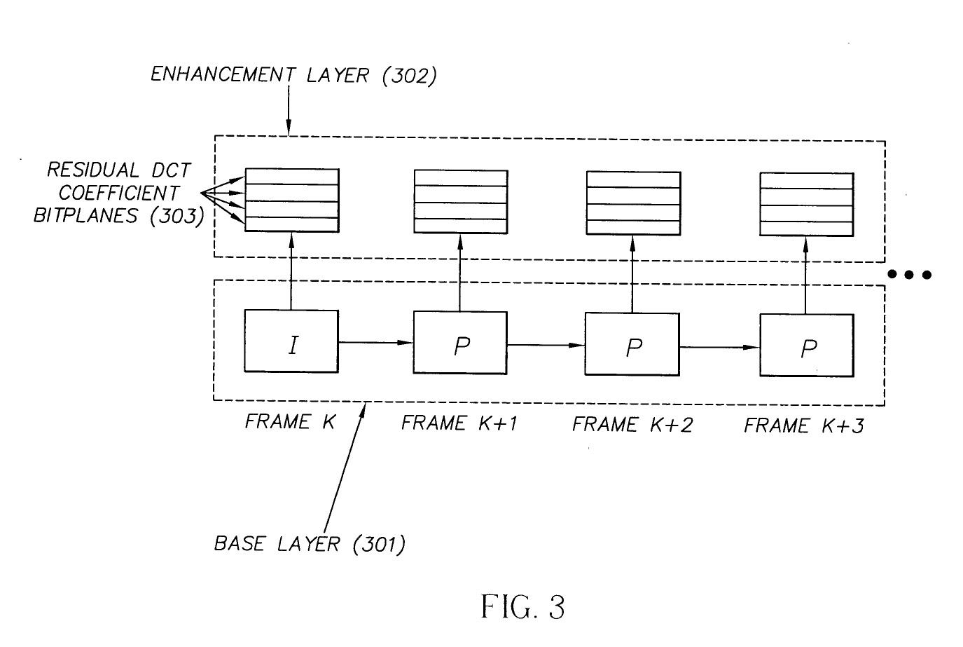

The blocks in FIG. 1 and FIG. 2 will now be described in more detail with reference to a preferred embodiment. For a monocular video sequence, the preferred embodiment of the video compression unit (102) is based on the fine granularity scalability (FGS) of the streaming video profile of the MPEG 4 standard as described in Li (“Overview of Fine Granularity Scalability in MPEG-4 Video Standard”, IEEE Transactions on Circuits and Systems for Video Technology, March 2001). FGS results in a compressed video bitstream as outlined in FIG. 3. The compressed bitstream contains a base layer (301) and an enhancement layer (302). The base layer is formed as a non-scalable, low-rate MPEG-compliant bitstream. In a preferred embodiment of the present invention, the base layer is restricted to ‘I’ and ‘P’ frames. ‘I’ frames are encoded independently. ‘P’ frames are encoded as a prediction from a single temporally previous reference frame, plus an encoding of the residual prediction error. ‘B’ frames allow bidirectional prediction. As will be discussed in the following, this base layer restriction to ‘I’ and ‘P’ frames is preferred so that the transmission order of the video frames matches the display order of the video frames, allowing accurate foveation processing of each frame with minimal buffering. For each frame, the enhancement layer (302) contains a bit-plane encoding of the residual discrete cosine transform (DCT) coefficients (303). For ‘I’ frames, the residual DCT coefficients are the difference between the DCT coefficients of the original image and the DCT coefficients encoded in the base layer for that frame. For ‘P’ frames, the residual DCT coefficients are the difference between the DCT coefficients of the motion compensated residual and the DCT coefficients encoded in the base layer for that frame.

While the previously described video compression unit is based on fine granularity scalability of the streaming video profile of MPEG 4, those skilled in the art will recognize that fine granularity scalability can be replaced with progressive fine granularity scalability, as described in Wu et. al. (“A Framework for Efficient Progressive Fine Granularity Scalable Video Coding,” IEEE Transactions on Circuits and Systems for Video Technology, March 2001). Similarly, MPEG-based encoding of the base layer can be replaced with a more efficient encoding, such as the emerging H.26L technology (“H.26L-based fine granularity scalable video coding,” ISO/IEC JTC1/SC29/WG11 M7788, December 2001).

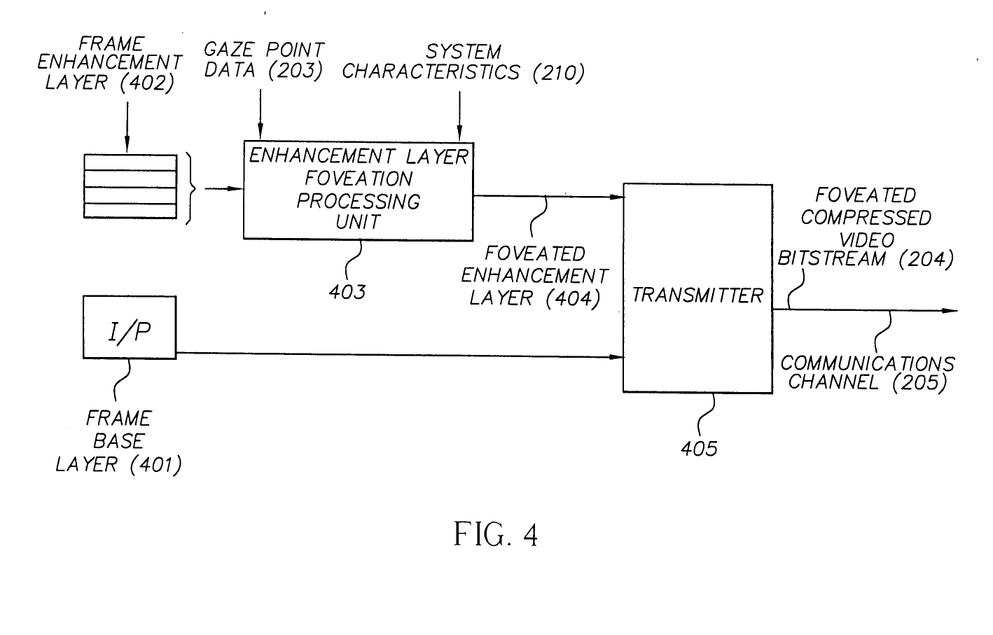

Once the video sequence is compressed, it is stored, and is ready for future acquisition by the video transcoding and transmission unit (201). For a monocular video sequence, FIG. 4 shows the preferred embodiment of the video transcoder and transmitter (201). Each frame of the compressed video sequence is processed independently. The base layer compressed data (401) of the frame passes unchanged through the transcoder. The enhancement layer compressed data (402) of the frame is input to the enhancement layer foveation processing unit (403) which also takes as input the observer's (209) current gaze point (203a) on the display (208) and the system characteristics (210). The enhancement layer foveation processing unit modifies the enhancement layer (402) based on the gaze point and system characteristics, and outputs the foveated enhancement layer (404). The base layer (401) and foveated enhancement layer (404) are then sent by the transmitter (405) across the communications channel (205). The enhancement layer foveation processing unit (403) modifies the enhancement layer based on the current gaze point of the observer. By restricting the base layer of the compressed video sequence to ‘I’ and ‘P’ frames, the frame being transcoded is always the next frame to be displayed, and thus the current gaze point information is always used to modify the compressed stream of the next frame to be transmitted and displayed, as desired. Those skilled in the art will recognize, however, that if there is sufficient storage at the decoder to buffer an additional decoded frame, it is also possible to use ‘B’ frames in the base layer to improve the coding efficiency of the base layer. In this case, the base layer for ‘P’ and ‘I’ frames must be transmitted out of display order, so that these frames can be used as references for ‘B’ frames. Data from the enhancement layer is not included in a reference used for motion compensation, however, and thus the enhancement layer for each frame can be transmitted in display order, allowing each enhancement layer frame to be foveated based on the appropriate current gaze information.

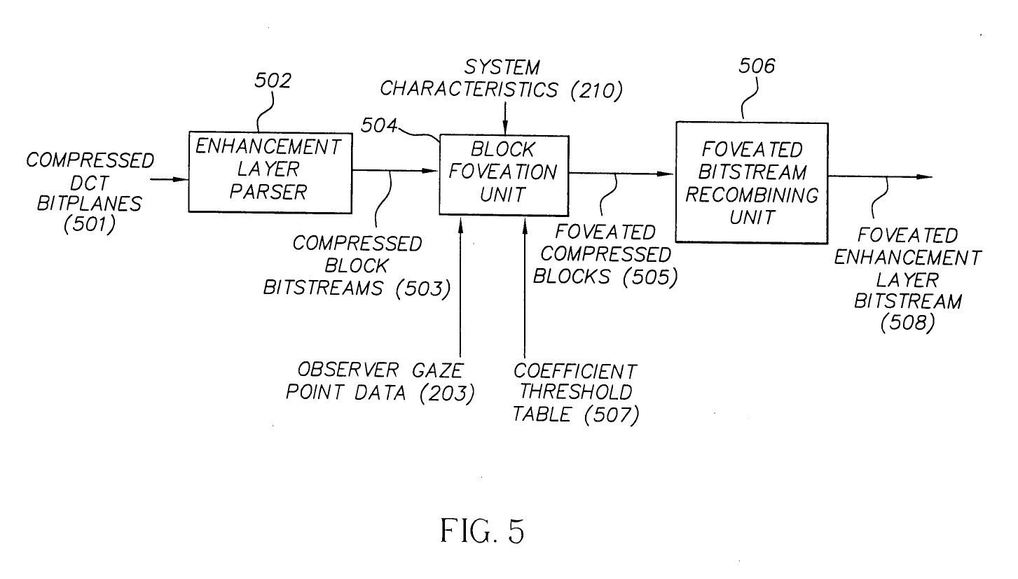

The enhancement layer foveation processing unit (403) will now be discussed in greater detail in FIG. 5. For a given compressed video frame, the enhancement layer contains a bit-plane encoding of residual DCT coefficients (501). Initially, this bitstream is separated by an enhancement layer parser (502) into the individual compressed bitstreams for each 8×8 DCT block (503). Each block is then processed independently by the block foveation unit (504). The block foveation unit also takes as input the observer's gaze point data (203), system characteristics (210), and a coefficient threshold table (507). The block foveation unit (504) decodes the residual DCT coefficients for a block, discards visually unimportant information, and recompresses the coefficients. The foveated compressed blocks (505) are then reorganized by the foveated bitstream recombining unit (506) into a single foveated enhancement layer bitstream (508).

Foveated image processing exploits the human visual system's decreasing sensitivity away from the point of gaze (203a). This sensitivity is a function of both spatial frequency as well as angular distance (referred to as eccentricity) from the gaze point. For any given spatial frequency f expressed in units of cycles per degree of visual angle, and eccentricity e expressed in degrees of visual angle, a contrast threshold function (CT) can be used to derive the minimum observable contrast for that frequency and eccentricity. Although many different contrast threshold formulae have been derived in the prior art, in a preferred embodiment, the contrast threshold function (CT) is given by:

$$CT ( f , e ) = [ N + \frac{η {σ}^{2}}{{f}^{2} + {σ}^{2}} ] exp ( α f + kfe ) . \qquad ( 1 )$$

where N, η, σ, and α are parameters with estimated values of 0.0024, 0.058, 0.1 cycle per degree, and 0.17 degree, respectively, for luminance signals at moderate to bright adaptation levels. These parameters can be adjusted for chrominance signals, which occur when an image is represented in a luminance/chrominance space for efficient compression. The parameters can also be adjusted to account for the decreased sensitivity that occurs when the adaptation level is decreased (which would occur with a low brightness display). Also, k is a parameter that controls the rate of change of the contrast threshold with eccentricity. In the preferred embodiment, the value of k will typically be between 0.030 and 0.057 with a preferred value of 0.045. Notice that based on Equation (1), the contrast threshold increases rapidly with eccentricity at high spatial frequencies. These relationships indicate that high spatial frequency information is only retrievable by the center of the retina.

In the proposed invention, the contrast threshold function is applied to individual DCT coefficients. The spatial frequency associated with a DCT coefficient c is computed based on the horizontal and vertical frequencies of the corresponding two-dimensional basis function:
f_{c}=\sqrt{(f_{c}^{h})²+(f_{c}^{v})²}, (2)
where f_{c}^{h} and f_{c}^{v} are the horizontal and vertical spatial frequencies, respectively, of the two-dimensional basis function associated with the DCT coefficient c. The frequencies f_{c}^{h} and f_{c}^{v} are also in units of cycles per degree of visual angle, and in a preferred embodiment, f_{c}^{h} and f_{c}^{v} are chosen to be the center of the horizontal and vertical frequency ranges, respectively, nominally associated with the two-dimensional DCT basis function.

The computation of the frequency in Equation (2) gives no indication of the orientation of the two-dimensional frequency. It is well known, however, that the human visual system is less sensitive to diagonal lines than to horizontal or vertical lines of equal frequency. The contrast threshold given by Equation (1) can be modified accordingly to account for orientation.

The eccentricity associated with a DCT coefficient c is given by:
e_{c}=\sqrt{(x_{c}−x₀)²+(y_{c}−y₀)²}, (3)
where (x₀, y₀) is the gaze point of the image, measured in degrees as a visual angle from the center of the image, and (x_{c}, y_{c}) is an angular measurement between the center of the image and the location of the DCT coefficient, where the location of the DCT coefficient is taken to be the spatial center of the corresponding DCT block. If a plurality of gaze points are present, the eccentricity can be taken to be the minimum of the individual eccentricities calculated over all gaze points.

The eccentricity can further be adjusted to account for error inherent in the gaze-location measurement. A conservative value of eccentricity is obtained by assuming the gaze-location estimate overestimates the actual eccentricity by an error of \tilde{e}. A revised estimate of the eccentricity used in Equation (1) is then given by
ê_{c}=e_{c}−\tilde{e}, (4)
if e_{c} is greater than \tilde{e}, and zero otherwise. The value of \tilde{e} affects the size of the region of the image that is transmitted at high fidelity. Larger values of \tilde{e} correspond to larger regions of the image transmitted at high fidelity.

For a DCT coefficient c, the threshold for the observable magnitude of that coefficient is given by:
T_{c}=L₀CT(f_{c},ê_{c}), (5)
where L₀ is the mean luminance value of the signal.

Thus a DCT coefficient c with magnitude less than T_{c} can be represented as having magnitude zero without introducing any visual error. This visually tolerable quantization error is assumed to be valid across all coefficient magnitudes. Hence T_{c} determines the number of visually unimportant bitplanes for that coefficient that can be discarded, based on the following formula:
discard_{c}=└log₂ T_{c}┘. (6)
Thus for an observable threshold less than 2, no bitplanes can be discarded. For a threshold between 2 and 4, one bitplane can be discarded, and so forth. For a coefficient c with magnitude greater than T_{c}, this quantization scheme is conservative, as a midpoint reconstruction of the coefficient guarantees a quantization error no greater then T_{c}/2. If additional compression is desired, the thresholds can be scaled in magnitude to result in increased discarded bitplanes.

To optimize the computation of the number of discardable bitplanes for each coefficient, a coefficient threshold table is computed off-line, and passed into the block foveation unit. The coefficient threshold table contains 64 rows, one row for each of the 64 coefficients in an 8×8 DCT block. Each row has several column entries. The n^{th} column entry, where the first column is n=1, indicates the minimum eccentricity at which a coefficient of the current row's spatial frequency can discard n bitplanes.

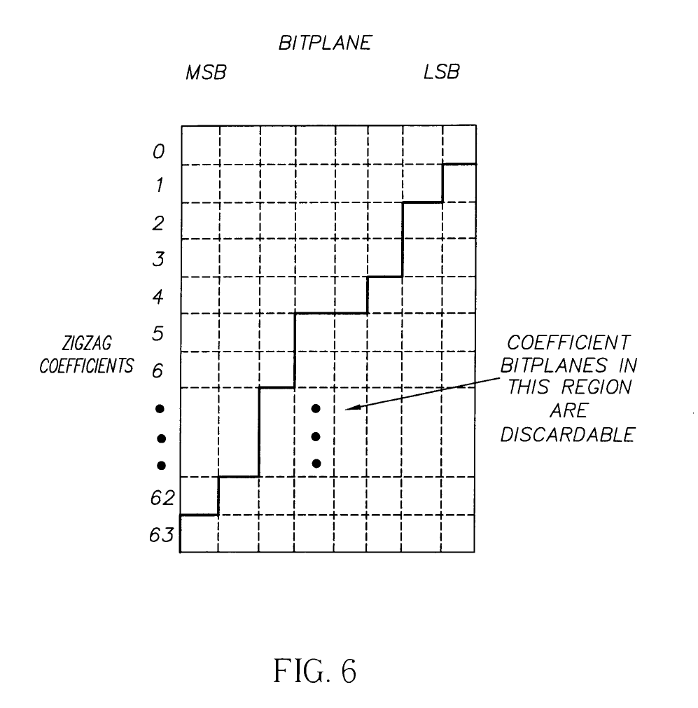

FIG. 6 shows an example of the discardable coefficient bitplanes for a DCT block in the enhancement layer. The horizontal axis indicates the bitplane, with the most significant bitplane on the left. The DCT coefficients are numbered from zero to 63 along the vertical axis, corresponding to the zig-zag ordering used to encode them. For each coefficient, there is a threshold bitplane, beyond which all of the remaining bitplanes can be discarded.

In a preferred embodiment of the block foveation unit (504), the compressed data for a DCT block is transcoded bitplane by bitplane. Each bitplane is decoded and recoded with all discardable coefficients set to zero. This increases the compression efficiency of the bitplane coding, as a string of zero coefficients concluding a DCT block bitplane can typically be encoded more efficiently than the original values. This scheme has the advantage that the compressed bitplanes remain compliant with the original coding scheme, and thus the decoder does not need any modification to be able to decode the foveated bitstream.

Inasmuch as the process according to the invention operates upon the DCT coefficients, it is helpful to understand that the encoded video need only be partially decoded to recover the frequency coefficients. The decoding thus described is “partial” because there is no requirement or need to perform an inverse DCT on the transformed data in order to practice the invention; instead, the transformed data is processed by an appropriate decoder (e.g., a Huffman decoder) to obtain the data. The foveation technique is then applied to the data, and the foveated data is re-encoded (i.e., transcoded) and transmitted to a display, where it is decoded and inverse transformed to get back to the original data, as now modified by the foveation processing.

In an alternative embodiment of the block foveation unit, the compressed data corresponding to discardable coefficients at the end of a DCT block bitplane are not replaced with a symbol representing a string of zeroes, but rather are discarded entirely. This scheme further improves compression efficiency, as the compressed data corresponding to the discardable coefficients at the end of a DCT block bitplane are completely eliminated. For the corresponding foveated bitstream to be decoded properly, however, the decoder must also be modified to process the same gaze point information and formulae used by the block foveation unit to determine which coefficient bitplanes have been discarded.

The foveated block bitstreams are input to the foveated bitstream recombining unit (506), which interleaves the compressed data. The foveated bitstream recombining unit may also apply visual weights to the different macroblocks, effectively bitplane shifting the data of some of the macroblocks when forming the interleaved bitstream. Visual weighting can be used to give priority to data corresponding to the region of interest near the gaze point.

JPEG2000-Based Foveated Video Coder

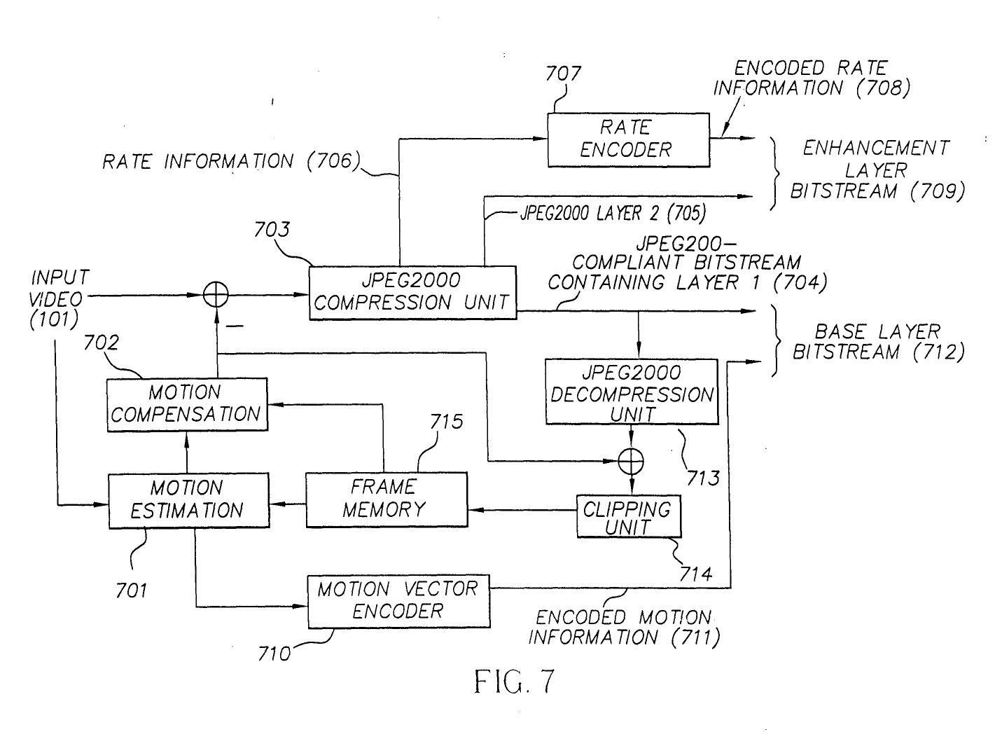

In an alternative embodiment of the invention, the video compression unit (102) is a JPEG2000-based video coder, where JPEG2000 is described in ISO/IEC JTC1/SC29 WG1 N1890, JPEG2000 Part I Final Committee Draft International Standard, September 2000. Temporal redundancies are still accounted for using motion estimation and compensation and the bitstream retains a base layer and enhancement layer structure as described for the preferred embodiment in FIG. 3. In the alternative embodiment, however, JPEG2000 is used to encode ‘I’ frames and also to encode motion compensated residuals of ‘P’ frames. FIG. 7 describes the video compression unit (102) in detail for the JPEG2000-based video coder.

The frame to be JPEG2000 encoded (the original input for ‘I’ frames; the motion residual for ‘P’ frames) is compressed in a JPEG2000 compression unit (703) using two JPEG2000 quality layers. Note that the term layer is used independently in describing both the organization of a JPEG2000 bitstream as well as the division of the overall video bitstream. The first JPEG2000 quality layer, as well as the main header information, form a JPEG2000-compliant bitstream (704) that is included in the base layer bitstream (712). The second quality layer (705) of the JPEG2000 bitstream is included in the enhancement layer bitstream (709). In a preferred embodiment of the JPEG2000-based compression unit, the compressed JPEG2000 bitstream is formed using the RESTART mode, such that the compressed bitstream for each codeblock is terminated after each coding pass, and the length of each coding pass is encoded in the bitstream. Alternatively, the JPEG2000 compression unit (703) outputs rate information (706) associated with each of the coding passes included in the second quality layer. This information is encoded by the rate encoder (707), and the encoded rate information (708) is included as part of the enhancement layer bitstream (709). Coding methods for the rate encoder are discussed in commonly-assigned, copending U.S. Ser. No. 10/108,151 (“Producing and Encoding Rate-Distortion Information Allowing Optimal Transcoding of Compressed Digital Image”).

The first layer of the JPEG2000 bitstream (704) is decoded in a JPEG2000 decompression unit (713) and added to the motion compensated frame for ‘P’ frames, or left as is for ‘I’ frames. The resulting values are clipped in a clipping unit (714) to the allowable range for the initial input, and stored in a frame memory (715) for use in motion estimation (701) and motion compensation (702) for the following frame. Motion vectors determined in the motion estimation process are encoded by the motion vector encoder (710). The encoded motion vector information (711) is included in the base layer bitstream (712).

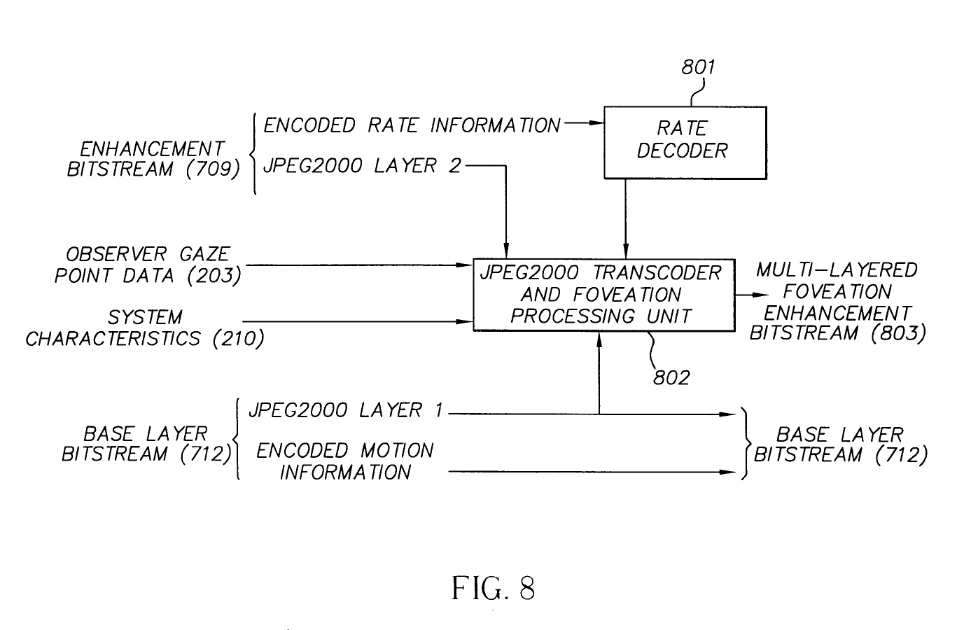

The JPEG2000-based compressed video bitstream is stored for subsequent retrieval and transmission to a decoder and ultimately a display. FIG. 8 shows in detail the video transcoding and transmission unit (201) used to produce a foveated compressed video bitstream in the case of JPEG2000 compressed video input. If RESTART mode is used for the JPEG2000 compressed bitstream, the length of each compressed coding pass contained in the bitstream can be extracted from the packet headers in the bitstream. Alternatively, rate information encoded separately can be passed to a rate decoder (801), which decodes the rate information for each coding pass and passes this information to the JPEG2000 transcoder and foveation processing unit (802). The entire JPEG2000 stream, along with the observer gaze point data (203) and system characteristics (210), are also sent to the JPEG2000 transcoder and foveation processing unit (802). The JPEG2000 transcoder and foveation processing unit leaves the base layer bitstream unchanged from its input. It outputs the multi-layered foveated enhancement bitstream (803).

Each JPEG2000 codeblock corresponds to a specific region of the image and a specific frequency band. This location and frequency information can be used as in the previous DCT-based implementation to compute a contrast threshold for each codeblock, and correspondingly a threshold for the minimum observable coefficient magnitude for that codeblock. All coding passes encoding information for bitplanes below this threshold can be discarded. This can be done explicitly, by discarding the compressed data. Alternatively, the discardable coding passes can be coded in the final layer of the multi-layered foveated bitstream, such that the data is only transmitted in the case that all more visually important data has been transmitted in previous layers, and bandwidth remains for additional information to be sent.

In a preferred embodiment of the JPEG2000-based transcoder and foveation processing unit (802), the eccentricity angle between the gaze point and a codeblock is based on the shortest distance between the gaze point and the region of the image corresponding to the codeblock. Alternatively, the eccentricity can be based on the distance from the gaze point to the center of the region of the image corresponding to the codeblock. The horizontal and vertical frequencies for each codeblock are chosen to be the central frequencies of the nominal frequency range associated with the corresponding subband. Given these horizontal and vertical frequencies, the two-dimensional spatial frequency for a codeblock can be calculated as previously in Equation (2). Finally, the contrast threshold and minimum observable coefficient magnitude for the codeblock can be calculated as previously in Equations (1) and (5). Rate information available for each coding pass is used to determine the amount of compressed data that can be discarded from each codeblock's compressed bitstream.

Among the visually important information to transmit, several layering schemes are possible. In one scheme, the foveated data is aggregated in a single layer. Alternatively, the data can be ordered spatially, such that all coding passes corresponding to codeblocks near the gaze point are transmitted in their entirety prior to the transmission of any data distant from the gaze point.

In the JPEG2000-based video coding scheme, multiple JPEG2000 layers can be included in the foveated enhancement layer to provide scalability during transmission. JPEG2000 layer boundaries can be chosen so that the data included in a particular layer approximates one bitplane of data per coefficient. Finer granularity can be introduced with minimal overhead cost by including additional layers in the foveated enhancement bitstream. The enhancement bitstream is then transmitted in layer progressive order while bandwidth remains.

Matching Pursuits-Based Foveated Video Coder

In another alternative embodiment of the invention, the video compression unit (102) utilizes matching pursuits, as described in (“Very Low Bit-Rate Video Coding Based on Matching Pursuits,” Neff and Zakhor, IEEE Transactions on Circuits and Systems for Video Technology, February 1997), to encode prediction residuals. In this embodiment, a dictionary of basis functions is used to encode a residual as a series of atoms, where each atom is defined as a particular dictionary entry at a particular spatial location of the image at a particular magnitude quantization level. During foveation, atoms may be discarded or more coarsely quantized based on their spatial frequency and location relative to the point of gaze.

Foveation Coding for Stereo Video Sequences

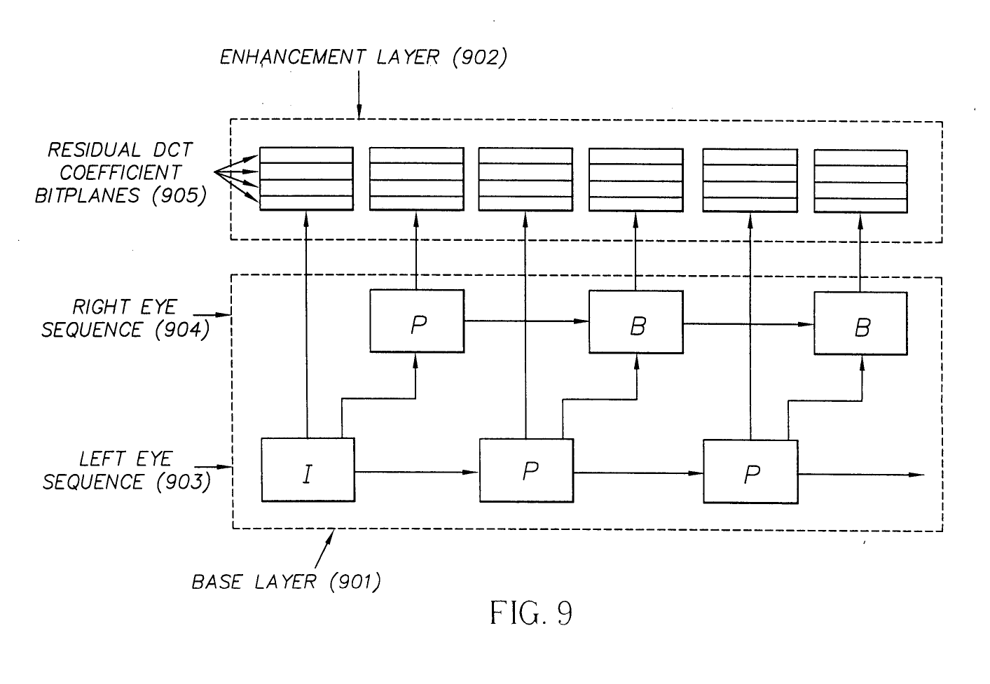

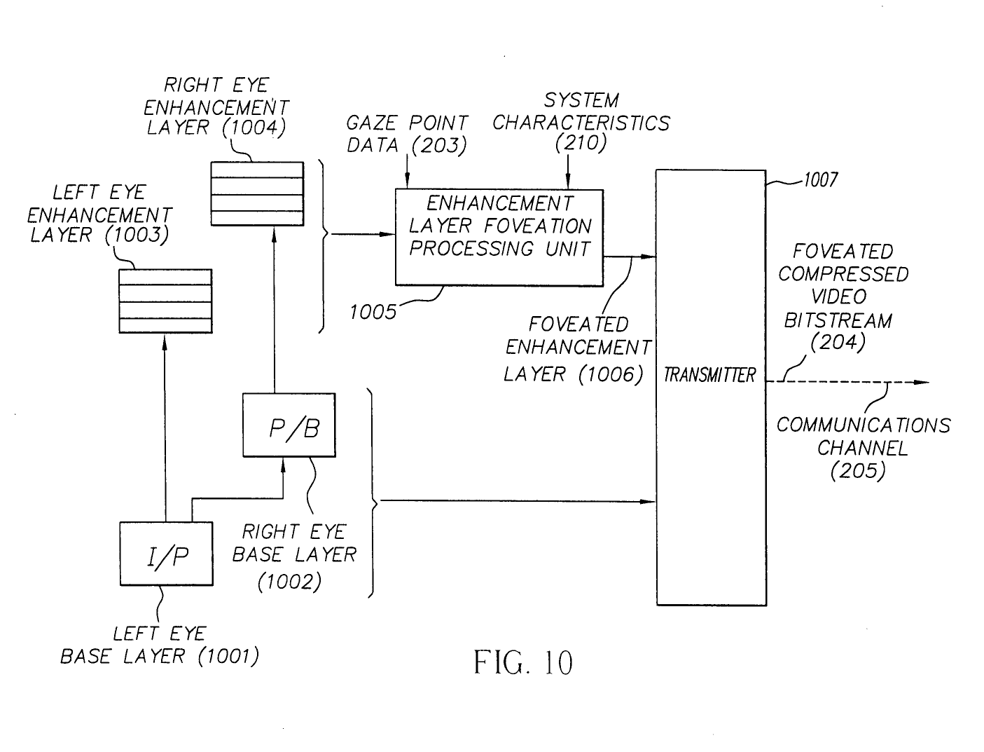

The previously described base layer and enhancement layer structure for encoding, transcoding and transmitting foveated video can also be modified to incorporate stereo video sequences. For the present invention, preferred embodiments of the video compression unit (102) and video transcoding and transmission unit (201) for encoding, transcoding and transmitting stereo video are detailed in FIG. 9 and FIG. 10.

In FIG. 9, the stereo video is compressed using a base layer (901) and enhancement layer (902). The base layer is formed using the multiview profile of the MPEG 2 video coding standard. Specifically, the left eye sequence of the base layer (903) is encoded using only ‘I’ and ‘P’ frames. The right eye sequence (904) is encoded using ‘P’ and ‘B’ frames, where the disparity estimation is always from the temporally co-located left eye image, and the motion estimation is from the previous right eye image. Although in MPEG 2 the right eye sequence fulfills the role of the temporal extension and is itself considered an enhancement layer, in the present invention, the entire MPEG 2 bitstream created using the multiview profile is considered to be the base layer. As in the case for monocular video, the enhancement layer contains a bitplane encoding of the residual DCT coefficients of each frame (905).

FIG. 10 details the video transcoding and transmission unit (201) for a stereo application. Corresponding to each stereo frame that the observer sees, there are both a left eye frame and a right eye frame that are processed using foveation information. The left eye base layer (1001), containing both the ‘I’ or ‘P’ frame corresponding to the left eye view, and the right eye base layer (1002), containing both the ‘P’ or ‘B’ frame corresponding to the right eye view, are passed unchanged to the video transmitter (1007). The enhancement layers (1003 and 1004), containing the bitplane DCT data for both left and right eyes respectively, are passed into the enhancement layer foveation processing unit (1005) along with the gaze point data (203) and system characteristics (210). The left eye and right eye enhancement layers (1003 and 1004) are processed independently using the foveation processing algorithm illustrated in FIG. 5 for monocular data. The resulting foveated enhancement layer data (1006) is passed to the transmitter (1007), where it is combined with the base layer to form the foveated compressed video bitstream (204) and transmitted across the communications channel (205).

Stereo mismatch may be introduced into a stereo encoding scheme by encoding one view at a higher fidelity than the other view. In the base layer (as illustrated in FIG. 9), this can typically be achieved by encoding the second view, represented by the right eye sequence (904), at a lower quality than the first view, represented by the left eye sequence (903). In the enhancement layer, mismatch may be introduced by encoding fewer DCT bitplanes for one view than for the other. In a preferred embodiment, stereo mismatch is introduced during foveation by scaling the contrast thresholds computed for one view, so that additional information is discarded from this view.

Those skilled in the art will recognize that in the previous stereo encoding scheme as illustrated in FIGS. 9 and 10, the roles of the left and right eye sequences can be exchanged.

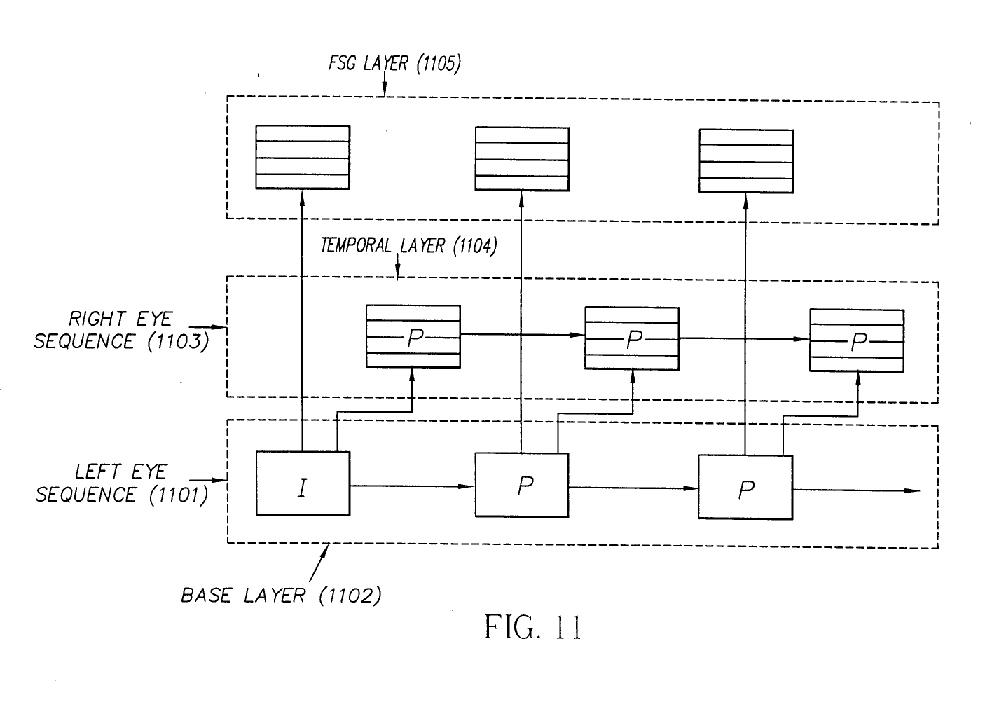

In an alternative embodiment of the video compression unit for stereo sequences, the sequence is encoded using the temporal scalability extension of the MPEG 4 streaming video profile. FIG. 11 details the corresponding video compression unit. The left eye sequence (1101) is compressed at low bit rate using an MPEG 2 non-scalable bitstream employing ‘I’ and ‘P’ frames to form the base layer (1102). The right eye sequence (1103) is encoded into the temporal layer (1104). Each right eye frame is motion compensated from the corresponding base layer (left eye) frame, and bitplane DCT coding is used for the entire residual. A final layer, referred to as the fine granularity scalability (FGS) layer (1105), contains a bitplane DCT coding of the residual for each frame in the base layer. The temporal layer and FGS layer are sent to a foveation processing unit, as in FIG. 10, to create the foveated bitstream.

In another embodiment of the invention for stereo video, DCT coding and subsequent foveation processing is replaced with JPEG2000 coding and subsequent foveation processing, as described in the section on JPEG2000-based foveation video coding.

In another embodiment of the invention for stereo video, matching pursuits, as described in the section on matching pursuits-based video coding, is used for the encoding and subsequent foveation of stereo prediction residuals.

Further modification and variation can be made to the disclosed embodiments without departing from the subject and spirit of the invention as defined in the following claims. Such modifications and variations, as included within the scope of these claims, are meant to be considered part of the invention as described.

### Parts List

101 original video sequence
102 video compression unit
103 compressed video bitstream
104 compressed video storage unit
201 video transcoding and transmission unit
202 gaze-tracking device
203 gaze point data
203a point of gaze
204 foveated compressed video bitstream
205 communications channel
206 video decoding unit
207 decoded video
208 display
209 observer
210 system characteristics
301 base layer
302 enhancement layer
303 residual DCT coefficient bitplanes
401 frame base layer
402 frame enhancement layer
403 enhancement layer foveation processing unit
404 foveated enhancement layer
405 transmitter
501 compressed residual DCT bitplanes
502 enhancement layer parser
503 compressed block bitstreams of 8×8 DCT blocks
504 block foveation unit
505 foveated compressed blocks
506 foveated bitstream recombining unit
507 coefficient threshold table
508 foveated enhancement layer bitstream
701 motion estimation
702 motion compensation
703 JPEG2000 compression unit
704 JPEG2000-compliant bitstream containing layer 1
705 JPEG2000 layer 2
706 rate information
707 rate encoder
708 encoded rate information
709 enhancement bitstream
710 motion vector encoder
711 encoded motion information
712 base layer bitstream
713 JPEG2000 decompression unit
714 clipping unit
715 frame memory
801 rate decoder
802 JPEG2000 transcoder and foveation processing unit
803 multi-layered foveation enhancement bitstream
901 base layer
902 enhancement layer
903 left eye sequence
904 right eye sequence
905 residual DCT coefficient bitplanes
1001 left eye base layer
1002 right eye base layer
1003 left eye enhancement layer
1004 right eye enhancement layer
1005 enhancement layer foveation processing unit
1006 foveated enhancement layer
1007 transmitter
1101 left eye sequence
1102 base layer
1103 right eye sequence
1104 temporal layer
1105 FGS layer

1. A method for transcoding a frequency transform-encoded digital video signal representing a sequence of video frames to produce a compressed digital video signal for transmission over a limited bandwidth communication channel to a display, said method comprising the steps of:
(a) providing a frequency transform-encoded digital video signal having encoded frequency coefficients representing a sequence of video frames, wherein the encoding removes temporal redundancies from the video signal and encodes the frequency coefficients as base layer frequency coefficients in a base layer and as residual frequency coefficients in an enhancement layer;
(b) identifying a gaze point of an observer on the display;
(c) partially decoding the encoded digital video signal to recover the frequency coefficients;
(d) adjusting the residual frequency coefficients to reduce the high frequency content of the video signal in regions away from the gaze point;
(e) recoding the frequency coefficients, including the adjusted residual frequency coefficients, to produce a foveated transcoded digital video signal; and
(f) displaying the foveated transcoded digital video signal to the observer.

2. The method according to claim 1, wherein the transform-encoded digital video signal is a stereo video signal and the encoding removes stereo redundancies from the stereo video signal, and wherein the adjusting and recoding steps (d) and (e) are applied to two views.

3. The method according to claim 1, wherein a discrete cosine transform (DCT) is used to generate the frequency coefficients.

4. The method according to claim 3, wherein fine granularity scalability according to the streaming video profile of MPEG 4 is used to generate the encoded digital video signal.

5. The method according to claim 1, wherein a wavelet transform is used to generate the frequency coefficients.

6. The method according to claim 5, wherein the frequency coefficients are encoded according to the JPEG2000 standard.

7. The method according to claim 1, wherein very low bit-rate video coding based on matching pursuits is used to generate the frequency coefficients.

8. The method according to claim 1, wherein the residual frequency coefficients are adjusted in step (d) according to an eccentricity-dependent model of a contrast threshold function of the human visual system.

9. The method according to claim 8, wherein the eccentricity-dependent model of the contrast threshold function of the human visual system indicates a maximum visually unnoticeable error for each residual frequency coefficient.

10. The method according to claim 8, wherein the eccentricity accounts for possible error in the estimate of the observer's point of gaze.

11. The method according to claim 4, wherein information content of the frequency coefficients is reduced by setting visually insignificant DCT coefficient bitplanes to zero.

12. The method according to claim 4, wherein information content of the frequency coefficients is reduced by discarding visually insignificant DCT coefficient bitplanes.

13. The method according to claim 4, wherein DCT coefficients corresponding to a region of interest at the gaze point are bit-plane shifted by applying visual weights during recoding in step (e) to give priority to these coefficients in the transcoded video signal.

14. The method according to claim 6, wherein information content of the frequency coefficients is reduced by discarding visually insignificant codeblock bitplane coding passes.

15. The method according to claim 6, wherein compressed data corresponding to a region of interest at the gaze point are given priority in the transcoded digital video signal.

16. The method according to claim 7, wherein a dictionary of basis functions is used to encode a prediction residual as a series of atoms, and information content of the frequency coefficients is reduced by discarding or coarsely quantizing visually insignificant atoms.

17. A system for transcoding a frequency transform-encoded digital video signal representing a sequence of video frames to produce a compressed digital video signal for transmission over a limited bandwidth communication channel, said system comprising:
(a) a memory containing an encoded digital video signal representing a sequence of video frames, wherein the encoding removes temporal redundancies from the video sequence and encodes the frequency coefficients as base layer frequency coefficients in a base layer and as residual frequency coefficients in an enhancement layer;
(b) a display for displaying the video signal to an observer;
(c) a gaze tracking device for identifying the observer's gaze point on the display;
(d) a decoding unit for partially decoding the encoded digital video signal to recover the frequency coefficients;
(e) a foveation processing unit for adjusting the residual frequency coefficients to reduce high frequency content of the video signal in regions away from the gaze point;
(f) a transcoding unit for recoding the frequency coefficients, including the adjusted residual frequency coefficients, to produce a foveated transcoded digital video signal; and
(g) means for transmitting and decoding the transcoded digital video signal and providing the decoded digital video signal to the display.

18. The system according to claim 17, wherein the digital video signal is a digital stereo video signal and the encoding also removes stereo redundancies from the digital stereo video signal.

19. The system according to claim 17, wherein the foveation processing unit includes a discrete cosine transform (DCT) for generating the frequency coefficients.

20. The system according to claim 19, wherein fine granularity scalability according to the streaming video profile of MPEG 4 is used to generate the encoded digital video signal.

21. The system according to claim 17, wherein the frequency coefficients are generated according to a wavelet transform.

22. The system according to claim 21, wherein the frequency coefficients are encoded according to the JPEG2000 standard.

23. The system according to claim 17, wherein the frequency coefficients are generated according to very low bit rate video coding based on a technique of matching pursuits.

24. The system according to claim 17, wherein the foveation processing unit for adjusting the frequency coefficients utilizes an eccentricity-dependent model of a contrast threshold function of the human visual system.

25. The system according to claim 24, wherein the eccentricity-dependent model of the contrast threshold function of the human visual system indicates a maximum visually unnoticeable error for each frequency coefficient.

26. The system according to claim 24, wherein the eccentricity model accounts for possible error in the estimate of the observer's point of gaze.

27. The system according to claim 20, wherein the foveation processing unit reduces information content of the frequency coefficients by setting visually insignificant DCT coefficient bitplanes to zero.

28. The system according to claim 20, wherein the foveation processing unit reduces information content of the frequency coefficients by discarding visually insignificant DCT coefficient bitplanes.

29. The system according to claim 20, wherein DCT coefficients corresponding to a region of interest at the gaze point are bit-plane shifted during transcoding to give priority to these coefficients in the transcoded digital video signal.

30. The system according to claim 22, wherein the foveation processing unit reduces the information content of frequency coefficients by discarding visually insignificant codeblock bitplane coding passes.

31. The system according to claim 22, wherein compressed data corresponding to the region of interest at the gaze point is given priority in the transcoded signal.

32. The system according to claim 23, wherein a dictionary of basis functions is used to encode a prediction residual as a series of atoms, and wherein the foveation processing unit reduces information content of the frequency coefficients by discarding or coarsely quantizing visually insignificant atoms.
